(19) United States
(12) Patent Application Publication
(10) Pub. No.: US 2024/0384376 A1
(43) Pub. Date: Nov. 21, 2024

(54) ALLOY, ALLOY MEMBER, APPARATUS, AND METHOD OF MANUFACTURING ALLOY

(71) Applicant: CANON KABUSHIKI KAISHA, Tokyo (JP)

(72) Inventors: HIROTOMO TAMIYA, Kanagawa (JP); KEIICHI ISHIZUKA, Saitama (JP); JUN-ICHI SAKAMOTO, Kanagawa (JP)

(21) Appl. No.: 18/664,093

(22) Filed: May 14, 2024

(30) Foreign Application Priority Data
May 17, 2023 (JP) 2023-081381

(51) Int. Cl. C22C 24/00; B64U 20/70; C22C 1/02; G03B 17/02; G06F 1/18

(52) U.S. Cl. CPC C22C 24/00; C22C 1/02; B64U 20/70; G03B 17/02; G06F 1/181

(57) ABSTRACT

An alloy contains Mg, Li, Al, and Zr. A sum of a content of the Mg and a content of the Li is 90 percent by mass or more. A content of the Zr is in a range of 0.6 percent by mass or more and 3.0 percent by mass or less. The alloy also contains Ge and/or Be. A total content of the Ge and/or the Be is in a range of 0.02 percent by mass or more and 0.4 percent by mass or less. The alloy also contains an unevenly distributed portion being smaller than a crystal grain, containing the Zr at a higher content ratio than a content ratio of the Zr in the crystal grain, and containing the Al.

### BACKGROUND

### Field of the Disclosure

The present disclosure relates to an alloy, an alloy member, an apparatus, and a method of manufacturing the alloy.

### Description of the Related Art

A magnesium-lithium-based (Mg—Li-based) alloy is lightweight and excellent in vibration-damping property and specific strength, and thus is expected to be utilized for various apparatuses. However, Li is a metallic element that is very active is easily ionized and dissolved. For this reason, the Mg—Li-based alloy has a tendency to corrode in a wet state. Additionally, hardness of the Mg—Li-based alloy is not sufficient as a structural material.

To increase the hardness, it is known to cause the Mg—Li-based alloy to contain Al. Japanese Patent Application Laid-Open No. 2019-189941 discloses an alloy obtained by causing a Mg—Li-based alloy containing Al to further contain Ge and/or Be to increase corrosion resistance and hardness.

However, increasing the hardness of the Mg—Li-based alloy raises a possibility of causing a decrease in toughness. Therefore, there is a case where the toughness of the Mg—Li-based alloy is insufficient and a crack is caused depending on a use condition and a manufacturing condition.

### SUMMARY

According to an aspect of the present disclosure, an alloy contains Mg, Li, Al, and Zr, a sum of a content of the Mg and a content of the Li being 90 percent by mass or more, a content of the Zr being in a range of 0.6 percent by mass or more and 3.0 percent by mass or less, Ge and/or Be, a total content of the Ge and/or the Be being in a range of 0.02 percent by mass or more and 0.4 percent by mass or less, and an unevenly distributed portion being smaller than a crystal grain, containing the Zr at a higher content ratio than a content ratio of the Zr in the crystal grain, and containing the Al.

According to another aspect of the present disclosure, a method of manufacturing an alloy includes heating a raw material to 700° C. or higher to melt the raw material, the raw material containing Mg, Li, Al, and Zr, a sum of a content of the Mg and a content of the Li being 90 percent by mass or more, a content of the Zr being in a range of 0.6 percent by mass or more and 3.0 percent by mass or less, the raw material further containing Ge and/or Be, a total content of the Ge and/or the Be being in a range of 0.02 percent by mass or more and 0.4 percent by mass or less, and cooling the melted raw material, wherein, in the cooling, a cooling rate until the melted raw material is solidified is 30° C. per hour or less, and a cooling rate from when the melted raw material is solidified to when a temperature is decreased to 150° C. is 50° C. per minute or more.

Further features of the present disclosure will become apparent from the following description of exemplary embodiments with reference to the attached drawings.

### BRIEF DESCRIPTION OF THE DRAWINGS

FIG. 1 is a schematic view illustrating an alloy member according to a first exemplary embodiment.

FIG. 2A is a conceptual view illustrating an alloy according to the first exemplary embodiment.

FIG. 2B is a conceptual view illustrating the alloy according to the first exemplary embodiment.

FIG. 3 is a flowchart illustrating manufacturing processes of the alloy according to the first exemplary embodiment.

FIG. 4 is a schematic view illustrating an apparatus according to a second exemplary embodiment.

FIG. 5 is a schematic view illustrating an apparatus according to a third exemplary embodiment.

FIG. 6 is a schematic view illustrating an apparatus according to a fourth exemplary embodiment.

FIG. 7 illustrates a scanning electron microscope (SEM) image in Example 1.

FIGS. 8A to 8D each illustrate a result of SEM-energy dispersive X-ray spectroscopy (EDS) analysis in Example 1.

FIG. 9 is an x-ray diffraction measurement diagram in Example 1 and Comparative Example 1.

### DESCRIPTION OF THE EMBODIMENTS

### [Alloy Member]

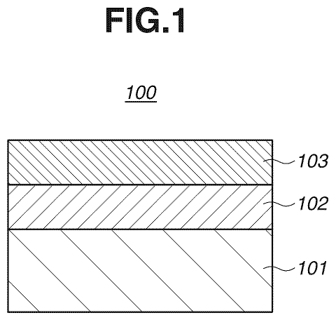

FIG. 1 is a schematic view illustrating an alloy member according to a first exemplary embodiment, and is a cross-sectional view in a case where the alloy member is cut in a lamination direction.

An alloy member 100 is an alloy member in which a parent material portion 101 of a base material, a first layer 102 of the base material, and an anticorrosion film 103 as a coat arranged on the first layer 102 of the base material are laminated. An application purpose of the alloy member according to the present exemplary embodiment is not specifically limited, and the alloy member can be used as, for example, a structure material, such as an exterior member of an apparatus including components, an interior member, and a slide member. In the present disclosure, an alloy member in an aspect without the anticorrosion film 103 is also referred to as the alloy member.

The base material contains a magnesium-lithium-based alloy (Mg—Li-based alloy).

In the present specification, the Mg—Li-based alloy refers to an alloy that contains Mg and Li and in which a sum of a content of Mg and a content of Li is 90 percent by mass or more. In a case where the sum of the content of Mg and the content of Li is 90 percent by mass or more, the Mg—Li-based alloy becomes more lightweight than a Mg alloy that does not contain Li. The Mg—Li-based alloy is a lightweight metal material and is more excellent in vibration-damping property and specific strength than the Mg alloy that does not contain Li. Being excellent in the vibration-damping property means that vibration is quickly converged by quick conversion of vibration energy into heat energy. In addition, the specific strength is a tensile strength divided by a density, and the higher the specific strength is, the more lightweight a member can be.

The alloy according to the present disclosure contains Al and Zr in addition to Mg and Li, and further contains Ge and/or Be. The alloy can further contain, besides the above-mentioned elements, at least one element selected from the group consisting of Zn, Ca, and Mn with the remainder being inevitable impurities and Mg.

The content of Li in the alloy according to the present disclosure is preferably in a range of 11 percent by mass or more and 13.5 percent by mass or less. In a case where the content of Li is in the above-mentioned range, the alloy has a single β phase at room temperature (for example, 25° C.). The β phase, since the alloy according to the present disclosure contains a large amount of Li, is also referred to as a body-centered cubic (bcc) phase. A crystal structure of the alloy in the 62 phase is a bcc structure. In a case where the alloy according to the present disclosure is in the single β phase, it becomes more lightweight than a case where the alloy is in an a phase.

A content of Al in the alloy according to the present disclosure is preferably in a range of 1 percent by mass or more and 5 percent by mass or less. In the alloy according to the present disclosure, Al plays a role of increasing disruptive strength of the alloy. For this reason, in a case where the content of Al is in the above-mentioned range, the alloy according to the present disclosure can have sufficient mechanical strength in comparison with a case where the alloy does not contain Al. This is thought to be due to Al reacting with Mg, and MgAl₂, which is a compound of Al and Mg, being deposited, whereby the mechanical strength is increased. The content thereof is more preferably in a range of 1 percent by mass or more and 4 percent by mass or less.

A total content of Ge and Be in the alloy according to the present disclosure is in a range of 0.02 percent by mass or more and 0.4 percent by mass or less. In the alloy according to the present disclosure, each of Ge and Be partially substitutes for Al, thereby playing a role of increasing corrosion resistance. Although a reaction between Al and Mg increases the mechanical strength of the Mg—Li-based alloy containing Al as described above, a lithium-rich grain boundary is segregated in a parent phase at this time, whereby the Mg—Li-based alloy has a tendency to corrode. However, by Al being partially substituted by an element having an atomic radius that is smaller than that of Al, such as Ge and Be, Ge or Be is positively disposed in the grain boundary instead of Li, whereby the segregation of Li into the grain boundary can be prevented. This can increase the corrosion resistance. A content of only Ge is preferably in a range of 0.01 percent by mass or more and 0.4 percent by mass or less. The content of only Ge is more preferably in a range of 0.01 percent by mass or more and 0.2 percent by mass or less. A content of only Be is preferably in a range of 0.02 percent by mass or more and 0.1 percent by mass or less. The content of only Be is more preferably in a range of 0.01 percent by mass or more and 0.05 percent by mass or less.

A content of Zr in the alloy according to the present disclosure is in a range of 0.6 percent by mass or more and 3.0 percent by mass or less. In a case where the content of Zr is 0.6 percent by mass or more, it is possible to crystallize an unevenly distributed portion containing Zr and Al, which will be described below, when a temperature that is a melting point or more of the alloy is decreased under a predetermined condition.

In a case where the content of Zr is less than 0.6 percent by mass, Zr does not crystallize and is incorporated approximately uniformly into crystal grains, and the alloy is in a solid solution state. The predetermined condition will be described below in a paragraph regarding a manufacturing method.

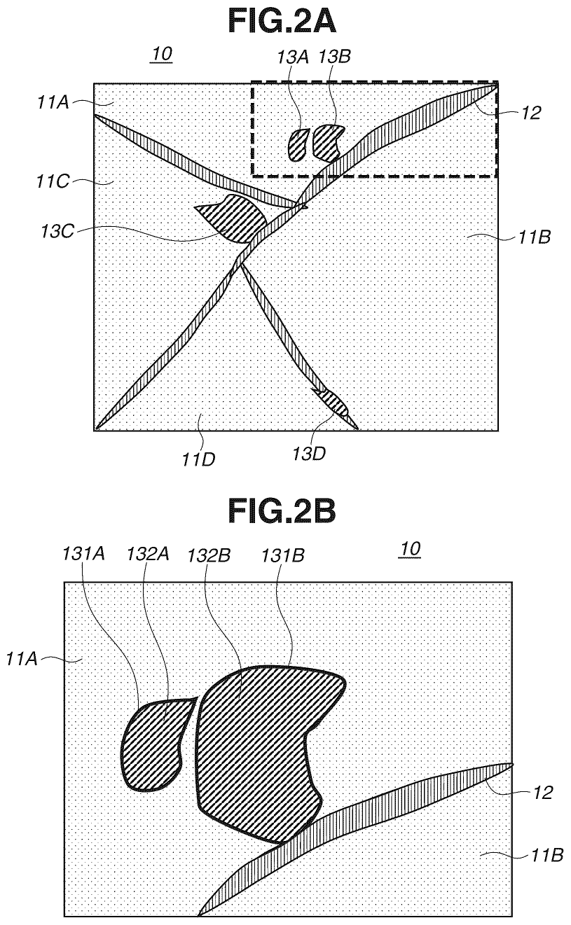

FIG. 2A is a conceptual view illustrating an alloy 10 according to the present disclosure when viewed with a scanning electron microscope or an electron microscope. FIG. 2B is a partial enlarged view in which a portion surrounded by a broken line in FIG. 2A is enlarged.

In FIG. 2A, the alloy 10 contains crystal grains 11A, 11B, 11C, and 11D (which may be hereinafter collectively referred to as a crystal grain 11) as a plurality of crystal grains. In addition, a grain boundary 12 exists between the plurality of crystal grains. In at least part of the crystal grain 11 and the grain boundary 12 in the alloy 10, unevenly distributed portions 13A, 13B, 13C, and 13D (which may be hereinafter collectively referred to as an unevenly distributed portion 13) exist. A content ratio of Zr in the unevenly distributed portion 13 is higher than that in the crystal grain 11. More specifically, the content of Zr in the unevenly distributed portion 13 is more than 3.0 percent by mass. The unevenly distributed portion 13 contains a larger amount of Al than the crystal grain 11 does. It is preferable that a main component of the unevenly distributed portion 13 be crystallized Zr or deposited Zr, and the unevenly distributed portion 13 contains Al in an amount smaller than an amount of Zr. More specifically, it is preferable that, in the unevenly distributed portion 13, the content of Zr be more than 50 percent by mass and the content of Al be less than 50 percent by mass. The unevenly distributed portion 13 is smaller than the crystal grain 11 of the alloy 10, and a long side thereof is 5 μm or more and 100 μm or less.

In FIG. 2B, the unevenly distributed portion 13A includes a main body 132A and a surface layer 131A that covers the main body 132A, and the unevenly distributed portion 13B includes a main body 132B and a surface layer 131B that covers the main body 132B (the main bodies 132A and 132B may be hereinafter collectively referred to as a main body 132, and the surface layers 131A and 131B may be hereinafter collectively referred to as a surface layer 131). In the alloy 10 according to the present disclosure, the surface layer 131 contains Al, and a content ratio of Al in the surface layer 131 is preferably higher than a content ratio of Al in the main body 132. In other words, Al is more highly concentrated in the surface layer 131 than in the main body 132.

An existing Mg—Li-based alloy containing Al contributes to an increase in strength, but MgAl₂, which degrades ductility and becomes an occurrence factor for a crack, is easily produced. However, in the present disclosure, Al is caused to be incorporated into Zr that crystallizes or deposits during a chemical reaction of the alloy 10, whereby the content of Al that reacts with Mg to produce the compound is decreased. Hence, since it is possible to make a production amount of MgAl2 smaller than that in a conventional technique, the present disclosure enables provision of the alloy 10 in which a crack is less likely to occur than in the conventional technique and that is excellent in ductility.

In a case where the unevenly distributed portion 13 such as the unevenly distributed portion 13A to 13C exists in part of the crystal grain 11, a crystallized substance produced by the above-mentioned crystallization is the main component. On the other hand, in a case where the unevenly distributed portion 13 such as the unevenly distributed portion 13D exists in the grain boundary 12, a deposit is the main component. The main component mentioned herein represents a component that is contained in the largest amount among all components. As the content of Zr increases, an amount of the deposit tends to increase.

In a case where the content of Zr exceeds 3.0 percent by mass, it becomes difficult for Al to exist in the above-mentioned unevenly distributed portion 13. This is thought to be because of the following reason. When the content of Zr is 3.0 percent by mass, a temperature reaches a peritectic point in a Mg—Zr binary phase diagram. In a case where the content of Zr exceeds that at the position of the peritectic point, it is assumed that a temperature at which solid and liquid phases exit becomes higher, a reaction between Al and Zr takes precedence, and an AlZr compound is produced.

Additionally, causing the alloy 10 according to the present disclosure to contain Zr can decrease an average grain diameter of the crystal grain 11. The average grain diameter of the crystal grain 11 is preferably 400 μm or less, and is more preferably 200μm or less. In a case where the average grain diameter of the crystal grain 11 is small, the number of grain boundaries 12 in the alloy 10 increases.

It is thought that an increase in the number of grain boundaries 12 disperses segregation of Ge, Be, or the like into the grain boundaries 12, decreases an amount of segregation per grain boundary, and consequently, brings about an increase in toughness of the alloy 10.

It is preferable that the alloy 10 according to the present disclosure contain at least one element selected from the group consisting of Zn, Ca, and Mn, and a sum of contents of elements of the group be in a range of 0.01 percent by mass or more and 5 percent by mass or less.

A content of Zn in the alloy 10 according to the present disclosure is preferably 3 percent by mass or less. In a case where the content of Zn is 3 percent by mass or less, the ductility becomes favorable. On the other hand, in a case where the content of Zn exceeds 3 percent by mass, there is a possibility that a process window becomes narrow although a mechanism is unknown. The content of Zn is more preferably 0.1 percent by mass or more and 2 percent by mass or less.

A content of Ca in the alloy 10 according to the present disclosure is preferably 1 percent by mass or less. In a case where the content of Ca is 1 percent by mass or less, the corrosion resistance becomes favorable. On the other hand, in a case where the content of Ca exceeds 1 percent by mass, the corrosion resistance may become a similar degree to that in a case where Ca is not contained. The content of Zn is more preferably in a range of 0.01 percent by mass or more and 0.4 percent by mass or less.

A content of Mn in the alloy 10 according to the present disclosure is preferably 0.3 percent by mass or less. In a case where the content of Mn is 0.3 percent by mass or less, the toughness becomes more favorable. On the other hand, in a case where the content of Mn exceeds 0.3 percent by mass, the corrosion resistance can become a similar degree to that in a case where Mn is not contained. The content of Mn is more preferably in a range of 0.01 percent by mass or more and 0.2 percent by mass or less.

The alloy 10 according to the present disclosure may contain a metallic element other than the elements exemplified above as long as characteristics thereof do not change. Examples of such a metallic element include inevitable impurities, which are unavoidable to be mixed into the alloy 10 in manufacturing. Examples of the inevitable impurities include Fe and Cu. The content of each element is 0.1 percent by mass or less, and a total content of inevitable impurities is 1 percent by mass or less.

The shape of the base material is not specifically limited. The shape is not limited to a hexahedron, such as a rectangular parallelepiped and a cube illustrated in FIG. 1, and may be a cylinder, a sphere, a prism, a cone, or a tube.

The first layer 102 is a portion formed on the surface of the base material. A concentration of Li in the first layer 102 is preferably lower than the concentration of Li in the parent material portion 101, which is a portion other than the surface layer of the base material. In other words, a concentration of Mg in the first layer 102 is preferably higher than the concentration of Mg in the parent material portion 101 of the base material. The first layer 102 refers not only to a portion on a side of the base material on which the anticorrosion film 103 is arranged, but also a bottom surface and a side surface of the base material. On other words, the first layer 102 may be formed on the left and right sides of the base material in the drawing or the bottom side in the drawing of FIG. 1. In a case where the concentration of Li in the first layer 102 is lower than the concentration of Li in the parent material portion 101 of the base material, the first layer 102 becomes less susceptible to corrosion than the parent material portion 101 of the base material. The larger the thickness (a length in a lamination direction) of the first layer 102 is, the less susceptible to corrosion the parent material portion 101 of the base material is. The thickness of the first layer 102 is preferably 10 um or more. The thickness of the first layer 102 is more preferably 30 um or more in terms of preventing deposition of Li. Meanwhile, in a case where the thickness of the first layer 102 is too large, a manufacturing process is elongated or a power supply that enables application of a high voltage becomes necessary. Thus, the thickness of the first layer 102 is preferably 100 um or less.

The anticorrosion film 103 can be arranged on the first layer 102. In FIG. 1, the anticorrosion film 103 is arranged on the first layer 102. The anticorrosion film 103 is a film that is arranged with an aim to prevent the surface of the base material (first layer 102) from being exposed to an atmosphere. The anticorrosion film 103 prevents Li on the surface of the base material from reacting with moisture in the atmosphere. The anticorrosion film 103 is a film made of inorganic compounds including inorganic fluoride. The inorganic fluoride is, for example, magnesium fluoride (MgF₂). A main component of the inorganic fluoride of the anticorrosion film 103 is MgF₂, and a ratio thereof is 90 percent by volume or more. The main component of the inorganic fluoride of the anticorrosion film 103 being MgF₂ can prevent corrosion of the base material. This is because MgF₂ has a property of being less reactive to moisture. The inorganic fluoride of the anticorrosion film 103 may contain, in addition to MgF₂, lithium fluoride (LiF) or an oxide as long as the ratio thereof is 10 percent by volume or less. A percent by volume of MgF₂ in the inorganic fluoride of the anticorrosion film 103 can be calculated based on, for example, 2θ-θ measurement of X-ray diffraction measurement. The thickness (the length in the lamination direction) of the anticorrosion film 103 is preferably 2 μm or more. This is because it is possible to sufficiently block water or moisture in the air over the whole of the first layer 102. The thickness of the anticorrosion film 103 is more preferably 5 μm or more. The thickness of the anticorrosion film 103 is still more preferably 20 μm or more.

In the alloy member 100, the anticorrosion film 103 may not be exposed. For example, a coating, such as a primer coating and a top coating, may be further arranged on the anticorrosion film 103 depending on a user's purpose. An example of the coating is a thermal barrier coating having a thermal barrier function. A material of the coating is, for example, a cured substance of a curing resin. The curing resin is, for example, a thermosetting resin and a photocurable resin.

As described above, since the alloy according to the present disclosure includes the unevenly distributed portion that is smaller than the crystal grain, in which a content ratio of Zr is higher than that in the crystal grain, and that contains Al, it is possible to provide the alloy member in which production of MgAl₂ is reduced in comparison with the conventional technique. Therefore, it is possible to provide the alloy that is less susceptible to a crack and more excellent in toughness than the conventional technique.

### (Method of Manufacturing Alloy)

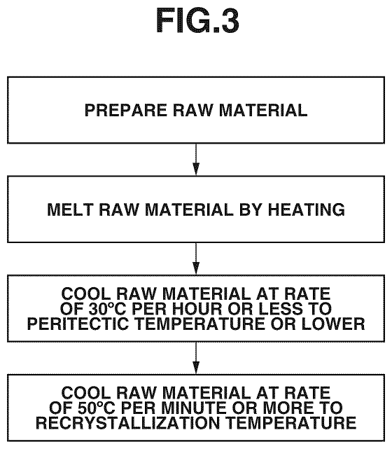

Subsequently, a method of manufacturing the alloy 10 according to the present disclosure is described with reference to FIG. 3. FIG. 3 is a flowchart illustrating manufacturing processes of the alloy 10.

First, raw materials of the Mg—Li-based alloy are prepared. Specifically, the metal raw materials are prepared to obtain a desired composition. A purity of a raw material is, for example, 4N, and a commercially available high-purity metal can be used. The form of each metal is not specifically limited. A desired form thereof can be selected from, for example, an ingot, chips, flakes, powder, shots, and pellets. However, each of Ge, Be, and Zr has a melting point higher than melting points of Mg, Li, and Al, and thus preferably an alloy with Mg is used.

Next, the raw materials are melted by heating using a vacuum melting furnace (heating process). In the heating step, the raw material is maintained at a temperature of 700° C. or higher in a vacuum or an atmosphere substituted by inert gas, and a melted metal is stirred so that components become uniform.

Then, the melted raw material is cooled (cooling process). Specifically, to produce the unevenly distributed portion 13 that is smaller than the crystal grain 11, in which the content ratio of Zr is high, and that contains Al in at least part of the crystal grain 11 of the alloy 10 and the grain boundary 12, first, the melted raw material is cooled at a rate of 30° C. per hour or less to a temperature in a range of solid-liquid coexistence and at a peritectic temperature or lower, so that the melted raw material is solidified. Then, the melted raw material is cooled at a rate of 50° C. per minute or more after the melted raw material is solidified until the temperature is decreased to 150° C. that is near a recrystallization temperature, whereby the alloy 10 according to the present disclosure can be obtained.

The obtained alloy 10 may be subjected to machine processing to make the obtained alloy 10 into a desired shape. As the machine processing, it is possible to appropriately select lapping processing, cutting machining, barrel polishing, or the like as needed. Additionally, cleaning may be performed on the obtained alloy 10. By cleaning, it is possible to remove a waste metal, dust, greasy dirt, an altered layer, or the like caused by the machine processing, such as the cutting machining. Thus, it is possible to use a typical cleaning method, such as cleaning with an acid or an alkali, cleaning with a surface-active agent, brush cleaning, and ultrasonic cleaning. After the cleaning, drying may be performed as needed.

With the obtained alloy 10 serving as the base material, the anticorrosion film 103 as a coat may be arranged on the base material.

A means for arranging the coat is not specifically limited, and can be selected as appropriate depending on the coat. In a case where the coat is magnesium fluoride or magnesium phosphate, it is possible to use chemical conversion treatment using a known anodization process or a known treatment liquid. Particularly, in a case where surface treatment is performed using a casting material, there is a case where color unevenness occurs due to variations in film thickness caused by segregation of Li. Hence, it is possible to perform solution treatment with an aim to uniformly disperse Li before the surface treatment. Furthermore, it is known that hardness is increased due to an aging effect by the solution treatment, and the high-hardness Mg—Li-based alloy can be obtained. —[Optical Apparatus and Imaging Apparatus]

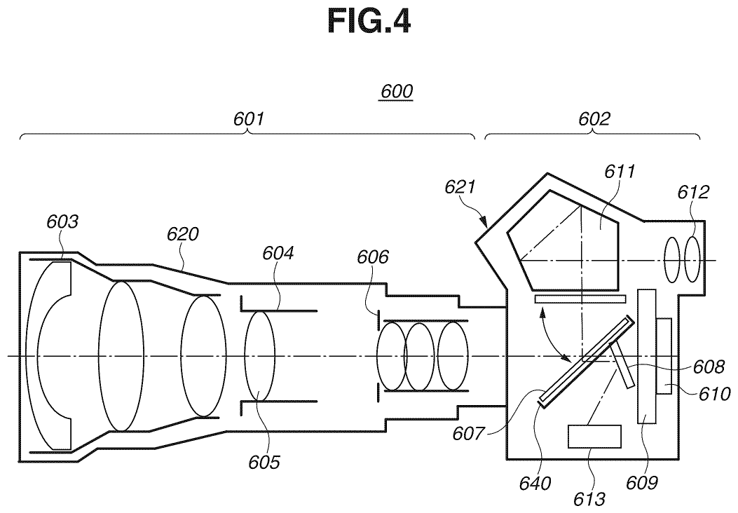

FIG. 4 illustrates a configuration of a single-lens reflex digital camera 600, which is an imaging apparatus as an example of an apparatus according to a second exemplary embodiment of the present disclosure. In FIG. 4, a camera main body 602 and a lens barrel 601, which is an optical apparatus, are joined together. The lens barrel 601 is an interchangeable lens that can be detachably mounted on the camera main body 602.

Light from an object passes through an optical system and received by an image pickup device, whereby imaging is performed. The optical system includes a plurality of lenses 603 and 605, which is an example of components arranged on an optical axis of an imaging optical system inside a housing of the lens barrel 601. The lens 605 is supported by an inner cylinder 604 and is movably supported with respect to an outer cylinder of the lens barrel 601 for focusing and zooming.

In an observation period before imaging, the light from the object is reflected on a main mirror 607, which is one example of the components inside a housing 621 of the camera main body 602, and penetrates a prism 611. Then, a captured image is projected for an operator through a finder lens 612. The main mirror 607 is, for example, a half mirror, and light having penetrated the main mirror 607 is reflected on a sub mirror 608 in a direction of an autofocus (AF) unit 613. This reflected light is used for, for example, distance measurement. Further, the main mirror 607 is mounted on and supported by a main mirror holder 640 by adhesion or the like. By a drive mechanism, which is not illustrated, the main mirror 607 and the sub mirror 608 are moved to the outside of an optical path at the time of imaging, a shutter 609 is opened, and a captured optical image incident from the lens barrel 601 is formed on an image pickup device 610. A diaphragm 606 is configured to be capable of changing brightness and a focal depth at the time of imaging by changing an aperture area.

The alloy member 100 can be used for at least part of housings 620 and 621. The housings 620 and 621 may be composed of only the Mg—Li-based alloy member, or a coating may be applied to the alloy member 100. Since the Mg—Li-based alloy according to the present disclosure is excellent in toughness, it is possible to provide the imaging apparatus that is more excellent in toughness than an existing imaging apparatus.

While the description has been given of the imaging apparatus by taking the single-lens reflex digital camera 600 as an example, the present disclosure is not limited thereto, and the imaging apparatus may be a smartphone or a compact digital camera.

### [Electronic Apparatus]

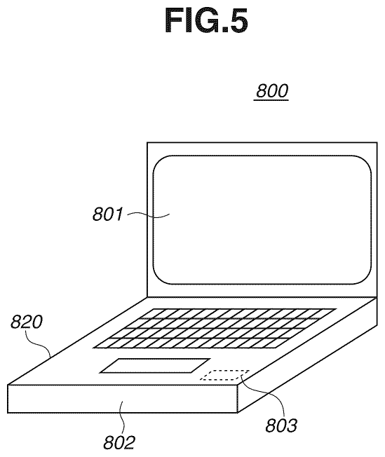

FIG. 5 illustrates a configuration of a personal computer that is an electronic apparatus, which is an example of an apparatus according to a third exemplary embodiment of the present disclosure. In FIG. 5, a personal computer 800 includes a display unit 801 and a main body 802. Inside a housing 820 of the main body 802, an electronic component 803, which is an example of components arranged inside the housing 820, is arranged. The alloy member 100 can be used for at least part of the housing 820 of the main body 802. The housing 820 may be composed of a Mg—Li-based alloy member only, or a coating may be arranged on the alloy member 100. Since the Mg—Li-based alloy according to the present disclosure is excellent in toughness, it is possible to provide the personal computer 800 that is more excellent in toughness than an existing personal computer.

While the description has been given of the electronic apparatus by taking the personal computer 800 as an example, the present disclosure is not limited thereto, and the electronic apparatus may be a smartphone or a tablet.

### [Mobile Object]

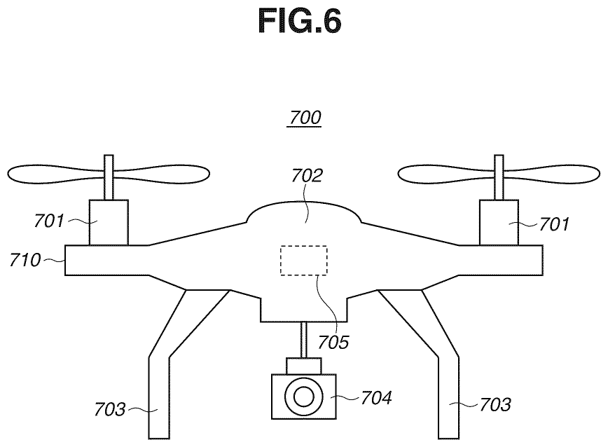

FIG. 6 illustrates a drone, which is an example of a mobile object according to a fourth exemplary embodiment of the present disclosure. A drone 700 includes a plurality of drive units 701, and a main body 702 that is connected with the plurality of drive units 701. A drive circuit 705 that is an example of components is arranged inside the main body 702. Each of the drive units 701 includes, for example, a propeller. As illustrated in FIG. 6, leg portions 703 may be connected to the main body 702, or a configuration in which a camera 704 is connected to the main body 702 may be adopted. The alloy member 100 can be used for at least part of a housing 710 for the main body 702 and the leg portions 703. The housing 710 may be composed of a Mg—Li-based alloy member only, or a coating may be arranged on the alloy member 100. Since the Mg—Li-based alloy according to the present disclosure is excellent in toughness, it is possible to provide the drone 700 that is more excellent in toughness than an existing drone.

While the description has been given of the mobile object by taking the drone 700 as an example, the present disclosure is not limited thereto, and the mobile object may be an automobile or an airplane.

### [EXAMPLES]

The present disclosure will be more specifically described below using examples. However, the present disclosure is not to be limited by the following examples.

### (Example 1)

First, a Mg metal was heated to 760° C. and melted in an argon atmosphere. Then, pieces of metals of Al, Zn, and Zr, and a piece of the Mg and Ge alloy were added so as to achieve a composition ratio as indicated in Table 1. After the addition of the pieces of metals and the piece of the alloy, a Mg alloy was cast and cooled using a mold, and an ingot of the Mg alloy was produced.

Next, the ingot of the Mg alloy was cut into small pieces, and the small pieces of Mg alloy and a piece of Li alloy were mixed in a ceramic crucible. The mixed alloys were melted again by high-frequency induction heating in an argon atmosphere at 850° C. Argon is inert gas.

Then, the obtained alloy was sufficiently electromagnetically stirred in the crucible and was left still at 700° C. for one hour. Subsequently, the alloy was slowly cooled at a rate of 30° C. per hour from 700° C. to 650° C., which is in a range of solid-liquid coexistence and at a peritectic temperature or lower, so that the alloy is solidified. Then, power supply for the high-frequency induction heating was turned off at a temperature below 650° C., and the material was cooled at a rate of 50° C. per minute or more during a period from when the melted raw material was solidified to when the temperature was decreased to 150° C. that is near a recrystallization temperature, whereby an alloy in Example 1 was obtained.

### (Example 2)

Example 2 is different in composition from Example 1. Processes similar to those in Example 1 except the difference in composition were performed, whereby an alloy in Example 2 was obtained.

### (Comparative Examples 1 to 5)

Comparative Examples 1 to 5 are different in composition from Example 1. Processes similar to those in Example 1 except the difference in composition were performed, whereby respective alloys in Comparative Examples 1 to 5 were obtained. [Evaluation of Alloy Member]

Now, an evaluation method used for Examples 1 and 2 and Comparative Examples 1 to 5, and results thereof are described. The results are summarized in Table 1.

### (Analysis of Composition)

Each element component of the alloys was analyzed by inductively coupled plasma atomic emission spectroscopy (ICP-AES). The alloy was processed into chips in a size of 2 mm or less, and the chips were dissolved in a solution and thereafter sprayed into plasma, whereby each element was atomized and caused to emit light. Since the emitted light has a wavelength specific to each element, the light was separated into spectra, and light intensity was measured, whereby a concentration of each element in the solution was measured.

A scanning electron microscope (SEM) image of a cross section observed at 50-power magnification was acquired using a field-emission-type scanning electron microscope (FE-SEM) (Sigma 500 VP, manufactured by Carl Zeiss AG), and energy dispersive x-ray spectroscopy (EDS) analysis was performed from the acquired image, whereby a composition of a microstructure was analyzed.

### (Average Grain Size)

An SEM image observed at 50-power magnification was acquired with use of a test piece obtained by embedding the alloy in a resin by a FE-SEM (Sigma 500 VP, manufactured by Carl Zeiss AG), and a crystal grain size was measured by line segment analysis from the acquired image. The test piece obtained by embedding was subjected to buffing, and then a crystal grain boundary was corroded with a nital solution. A line with a length of 1.5 mm was drawn in the SEM image, the number of intersections between the line and the grain boundary was counted, and an average line segment length was obtained. Three lines were drawn in each of a vertical direction and a horizontal direction, and the crystal grain size was obtained from an average value of ten SEM images.

### (Hardness)

Hardness was measured with use of a Rockwell hardness testing machine HR-430 MS (manufactured by Mitutoyo Corporation). With a measuring load being set at 60kgf, hardness HRF was measured using a steel ball with a diameter of 1.5875 mm. A block with a thickness of 10 mm or more was used as a test piece used for hardness measurement, a measurement surface was polished with emery paper No. 2000, and then the hardness HRF was measured.

### (Toughness)

A sheet-like material with a thickness of 1 mm, a length of 50 mm, and a width of 15 mm was cut out from a casting material, both sides of the sheet-like material were polished with the emery paper No. 2000, solution treatment was performed, and the presence/absence of a crack at this time was checked, whereby toughness was evaluated. In the solution treatment, a thin plate was placed on a hot plate, a thermocouple was attached to a top face of the thin plate (the opposite side of a hot plate surface), measurement was performed, and the thin plate was cooled with water as soon as a temperature of the top face of the thin plate reached 325° C. The sufficiently cooled thin plate was observed with an optical microscope to check for presence/absence of a crack. The presence of the crack was evaluated as B, and the absence of the crack was evaluated as A.

TABLE 1

| | | | | | | | | | Avg. | | | |
|---|---|---|---|---|---|---|---|---|---|---|---|---|
| | | | | | | | | | grain | Increased | | |
| | Component (percent by mass) | | | | | | | | size | hardness | Rockwell | |
| | Li | Al | Zn | Ca | Ge | Be | Mn | Zr | [μm] | ΔHRF | hardness | Toughness |
| Example 1 | 11.2 | 4.0 | 0.9 | | 0.19 | | | 1.2 | 172 | 46.3 | 98.7 | A |
| Example 2 | 11.8 | 3.5 | 1.1 | | 0.08 | | | 2.7 | 185 | 40.9 | 99.5 | A |
| Comparative | 11.9 | 3.9 | 1.0 | | | 0.03 | | | 453 | 28.8 | 95.0 | B |
| Example 1 | | | | | | | | | | | | |
| Comparative | 11.6 | 3.0 | | 0.22 | 0.36 | | | | 425 | 29.0 | 92.2 | B |
| Example 2 | | | | | | | | | | | | |
| Comparative | 11.5 | 3.4 | | 0.31 | 0.30 | 0.04 | 0.18 | | 419 | 32.8 | 96.4 | B |
| Example 3 | | | | | | | | | | | | |
| Comparative | 11.1 | 3.3 | | | 0.23 | | 0.02 | | — | — | — | B |
| Example 4 | | | | | | | | | | | | |
| Comparative | 12.2 | | 2.9 | | | | | 0.4 | 280 | −20.6 | 40.3 | B |
| Example 5 | | | | | | | | | | | | |

Based on the results in Table 1, in Examples 1 and 2 in which the alloy contains 0.6 percent by mass or more of Zr, the toughness was evaluated as A. In contrast, in Comparative Examples 1 to 4 in which the alloy does not contain Zr and Comparative Example 5 in which the alloy contains a low content ratio of 0.4 percent by mass of Zr, the toughness was evaluated as B.

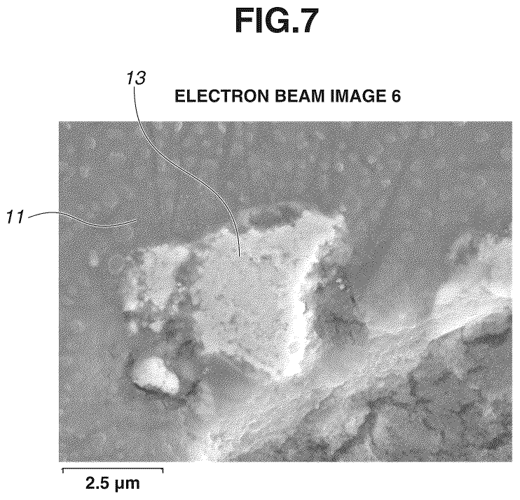

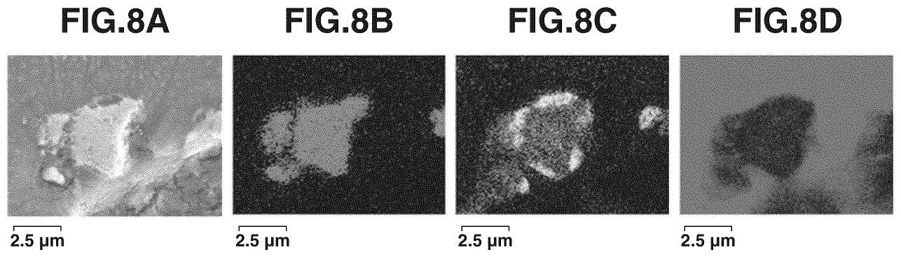

FIG. 7 illustrates an SEM image of the alloy in Example 1. FIG. 8A to 8D each illustrate a SEM-EDS image in Example 1. FIG. 8A is a reduced image of the image illustrated in FIG. 7, and FIGS. 8B to 8D are mapping diagrams. FIG. 8B is an EDS mapping diagram of L lines of Zr. FIG. 8C is an EDS mapping diagram of K lines of Al. FIG. 8D is an EDS mapping diagram of K lines of Mg. In this manner, in Example 1, the unevenly distributed portion 13 was confirmed at the grain boundary 12 of the crystal grain 11. It can be confirmed that the unevenly distributed portion 13 that contains Zr and Al is smaller than the crystal grain 11. Additionally, in Example 1, a large amount of Al was confirmed in the surface layer 131, and the unevenly distributed portion 13 was formed so that Al covered Zr.

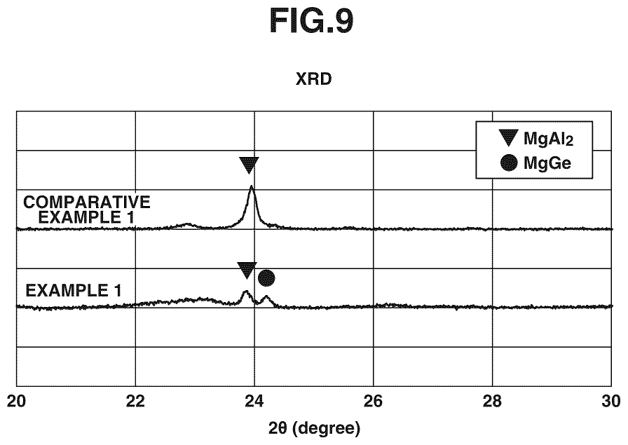

FIG. 9 is a measurement diagram illustrating an x-ray diffraction pattern acquired by 2θ-θ measurement of the alloys in Example 1 and Comparative Example 1. In this manner, it is clear that strength of MgAl₂ in Example 1 is decreased more than that in Comparative Example 1. Based on the above-mentioned results, it is assumed that the toughness of the alloy in Example 1 is more excellent than that of the alloy in each of Comparative Examples because a generation amount of MgAl₂ is suppressed.

The hardness in each of Examples 1 and 2 was higher than that in each of Comparative Examples. It was also confirmed that the hardness was increased particularly after the solution treatment.

The alloy according to the present disclosure can be used for an optical apparatus such as a lens barrel and a camera main body, various kinds of optical-related components of an imaging apparatus or the like, and a structural component of an electronic apparatus of various kinds such as a personal computer, a smartphone, and a tablet. The alloy according to the present disclosure can also be used for a structural component of a medical apparatus such as a flat panel detector of an X-ray digital radiography, a mobile object such as a drone, and other industrial apparatuses.

According to the exemplary embodiments of the present disclosure, it is possible to provide the alloy that has sufficient hardness and that is excellent in toughness.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-081381,filed May 17, 2023, which is hereby incorporated by reference herein in its entirety.

What is claimed is:

1. An alloy comprising:
Mg, Li, Al, and Zr, a sum of a content of the Mg and a content of the Li being 90 percent by mass or more, a content of the Zr being in a range of 0.6 percent by mass or more and 3.0 percent by mass or less;
Ge and/or Be, a total content of the Ge and/or the Be being in a range of 0.02 percent by mass or more and 0.4 percent by mass or less; and
an unevenly distributed portion being smaller than a crystal grain, containing the Zr at a higher content ratio than a content ratio of the Zr in the crystal grain, and containing the Al.

2. The alloy according to claim 1, wherein, in the unevenly distributed portion, the content of the Zr is larger than a content of the Al.

3. The alloy according to claim 1,
wherein the unevenly distributed portion includes a main body and a surface layer that covers the main body, and
wherein a content ratio of the Al in the surface layer is higher than a content ratio of the Al in the main body.

4. The alloy according to claim 1, wherein the content of the Zr is in a range of 1.0 percent by mass or more and 3.0 percent by mass or less.

5. The alloy according to claim 1, wherein an average grain diameter of the crystal grain of the alloy is 400 μm or less.

6. The alloy according to claim 1, wherein an average grain diameter of the crystal grain of the alloy is 200 μm or less.

7. The alloy according to claim 1,
wherein the unevenly distributed portion that exists in the crystal grain is a crystallized substance, and
wherein the unevenly distributed portion that exists in a grain boundary is a deposit.

8. The alloy according to claim 1, wherein the content of the Li is in a range of 11 percent by mass or more and 13.5 percent by mass or less.

9. The alloy according to claim 1, wherein a content of the Al is in a range of 1 percent by mass or more and 5 percent by mass or less.

10. The alloy according to claim 1,
wherein a content of the Ge is 0.04 percent by mass or more and 0.4 percent by mass or less, and
wherein a content of the Be is 0.02 percent by mass or more and 0.1 percent by mass or less.

11. The alloy according to claim 1, further comprising at least one element selected from the group consisting of Zn, Ca, and Mn,
wherein a sum of contents of elements in the group is in a range of 0.01 percent by mass or more and 5 percent by mass or less.

12. The alloy according to claim 11,
wherein the content of the Zn is 3 percent by mass or less, a content of the Ca is 1 percent by mass or less, and a content of the Mn is 0.3 percent by mass or less, and
wherein a remainder is inevitable impurities and the Mg.

13. An alloy member comprising:
a base material; and
a coat arranged on the base material,
wherein the base material contains the alloy according to claim 1.

14. The alloy member according to claim 13, wherein the coat contains magnesium fluoride or magnesium phosphate.

15. An apparatus comprising:
a housing; and
a component arranged inside the housing,
wherein the housing contains the alloy according to claim 1.

16. A method of manufacturing an alloy, the method comprising:
heating a raw material to 700° C. or higher to melt the raw material, the raw material containing Mg, Li, Al, and Zr, a sum of a content of the Mg and a content of the Li being 90 percent by mass or more, a content of the Zr being in a range of 0.6 percent by mass or more and 3.0 percent by mass or less, the raw material further containing Ge and/or Be, a total content of the Ge and/or the Be being in a range of 0.02 percent by mass or more and 0.4 percent by mass or less; and
cooling the melted raw material,
wherein, in the cooling, a cooling rate until the melted raw material is solidified is 30° C. per hour or less, and a cooling rate from when the melted raw material is solidified to when a temperature is decreased to 150° C. is 50° C. per minute or more.
